(19) United States
(12) Patent Application Publication
(10) Pub. No.: US 2014/0161085 A1
(43) Pub. Date: Jun. 12, 2014

(54) METHOD FOR TRANSMITTING AND RECEIVING RESOURCE ALLOCATION INFORMATION IN WIRELESS COMMUNICATION SYSTEM AND APPARATUS THEREFOR

(71) Applicants: Hakseong Kim, Anyang-si (KR); Hanbyul Seo, Anyang-si (KR)

(72) Inventors: Hakseong Kim, Anyang-si (KR); Hanbyul Seo, Anyang-si (KR)

(73) Assignee: LG ELECTRONICS INC., Seoul (KR)

(21) Appl. No.: 14/233,671

(22) PCT Filed: Jul. 19, 2012
(86) PCT No.: PCT/KR2012/005758

§ 371 Date: Jan. 17, 2014

Related U.S. Application Data
(60) Provisional application No. 61/509,554, filed on Jul. 19, 2011.

(51) Int. Cl. H04W 72/04

(52) U.S. Cl. CPC H04W 72/042
USPC 370/329

(57) ABSTRACT

Disclosed are a method for transmitting and receiving resource allocation information in a wireless communication system and an apparatus therefor. The method for a terminal to receive resource allocation information in a wireless communication system comprises the steps of: receiving, from a base station, an enhanced-physical downlink control channel (E-PDCCH) comprising a downlink (DL) grant from a particular resource domain; decoding a resource allocation (RA) field, which is in DCI format, in the received E-PDCCH; and determining, on the basis of the decoded RA field, whether a physical downlink shared channel (PDSCH) is transmitted from the domains in the particular resource domain from which the DL grant domain is excluded, or, from the domains in the particular resource domain in which an UL grant domain exists and from which the DL grant domain and the UL grant domain are excluded.

### TECHNICAL FIELD

The present invention relates to a wireless communication, and more particularly, to a method of transmitting and receiving resource allocation information in a wireless communication system and apparatus therefor.

### BACKGROUND ART

First of all, 3GPP LTE (3^{rd} generation partnership projecting long term evolution) communication system is schematically described for one example of a wireless communication system to which the present invention is applicable.

FIG. 1 is a schematic diagram for one example of E-UMTS network structure as a wireless communication system.

E-UMTS (evolved universal mobile telecommunications system) is the system evolved from a conventional UMTS (universal mobile telecommunications system) and its basic standardization is progressing by 3GPP. Generally, E-UMTS can be called LTE (long term evolution) system. For the details of the technical specifications of UMTS and E-UMTS, Release 7 and Release 8 of ‘3^{rd} Generation Partnership Project: Technical Specification Group Radio Access Network’ can be referred to.

Referring to FIG. 1, E-UMTS consists of a user equipment (UE), a base station and an access gateway (AG) provided to an end terminal of a network (E-UTRAN) to be connected to an external network. The base station is able to simultaneously transmit multi-data stream for a broadcast service, a multicast service and/or a unicast service.

At least one or more cells exist in one base station. The cell is configured to have one of bandwidths including 1.25 MHz, 2.5 MHz, 5 MHz, 10 MHz, 15 MHz, 20 MHz and the like and then provides an uplink or downlink transmission service to a plurality of user equipments. Different cells can be set to provide different bandwidths, respectively. A base station controls data transmissions and receptions for a plurality of user equipments. A base station sends downlink scheduling information on downlink (DL) data to inform a corresponding user equipment of time/frequency region for transmitting data to the corresponding user equipment, coding, data size, HARQ (hybrid automatic repeat and request) relevant information and the like. And, the base station sends uplink scheduling information on uplink (UL) data to a corresponding user equipment to inform the corresponding user equipment of time/frequency region available for the corresponding user equipment, coding, data size, HARQ relevant information and the like. An interface for a user traffic transmission or a control traffic transmission is usable between base stations. A core network (CN) can consist of an AG, a network node for user registration of a user equipment and the like. The AG manages mobility of the user equipment by a unit of TA (tracking area) including a plurality of cells.

The wireless communication technology has been developed up to LTE based on WCDMA (wideband code division multiple access) but the demands and expectations of users and service providers are continuously rising. Since other radio access technologies keep being developed, new technological evolution is requested to become competitive in the future. For this, reduction of cost per bit, service availability increase, flexible frequency band use, simple-structure and open interface, reasonable power consumption of user equipment and the like are required.

Recently, ongoing standardization of the next technology of LTE is performed by 3GPP. Such technology shall be named LTE-A. Big differences between LTE system and LTE-A system may include a system bandwidth difference and an adoption of a relay node.

The goal of LTE-A system is to support maximum 100 MZ wideband. To this end, LTE-A system uses carrier aggregation or bandwidth aggregation to achieve the wideband using a plurality of frequency blocks.

According to the carrier aggregation, a plurality of frequency blocks are used as one wide logical frequency band to use wider frequency band. And, a bandwidth of each frequency block may be defined based on a bandwidth of a system block used by LTE system. And, each frequency block is transmitted using a component carrier.

### DISCLOSURE OF THE INVENTION

### Technical Task

One technical task intended to achieve in the present invention is to provide a method for a user equipment to receive resource allocation information in a wireless communication system.

Another technical task intended to achieve in the present invention is to provide for a base station to receive resource allocation information in a wireless communication system.

Another technical task intended to achieve in the present invention is to provide a user equipment configured to receive resource allocation information in a wireless communication system.

A further technical task intended to achieve in the present invention is to provide a base station configured to receive resource allocation information in a wireless communication system.

Technical tasks obtainable from the present invention are non-limited the above mentioned technical tasks. And, other unmentioned technical tasks can be clearly understood from the following description by those having ordinary skill in the technical field to which the present invention pertains.

### TECHNICAL SOLUTION

To achieve the technical task and in accordance with the purpose of the present invention, as embodied and broadly described, a method of receiving a resource allocation information by a user equipment in a wireless communication system, may include receiving E-PDCCH (enhanced-physical downlink control channel) including a downlink (DL) grant on a specific resource region from a base station, decoding a resource allocation (RA) field of a DCI format of the received E-PDCCH, and determining whether PDSCH (physical downlink shared channel) is transmitted on the rest of the specific resource region except a DL grant region or the rest of the specific resource region except the DL grant region and a UL grant region existing in the specific resource region depending on a result of the decoded RA field. Preferably, the specific resource region may include a region configured by RBG (resource block group) or RB (resource block) unit. Preferably, the DL grant may be received by a unit of one of RBG (Resource Block Group), RB (Resource Block), slot, symbol, RE (Resource Element), eREG (enhanced Resource ElementG), eCCE (enhanced Control Channel Element) and combination thereof. Preferably, a location of the UL grant may include a pre-designated location or may be determined by the DL grant. More preferably, if the location of the UL grant is determined by the DL grant, the location of the UL grant may be determined based on one of indexes of RBG (Resource Block Group), RB (Resource Block), slot, symbol, RE (Resource Element), eREG (enhanced Resource ElementG) and eCCE (enhanced Control Channel Element), on which the DL grant is received. More preferably, the UL grant may be located by one of RBG (Resource Block Group) unit, RB (Resource Block) unit, slot unit, symbol unit, RE (Resource Element) unit, eREG (enhanced Resource ElementG) unit, eCCE (enhanced Control Channel Element) unit, subcarrier unit and unit configured by combination thereof. Preferably, the E-PDCCH may be received with the PDSCH by having FDM (frequency division multiplexing) applied thereto or by having a hybrid the FDM and TDM (time division multiplexing applied thereto.

To achieve another technical task and in accordance with the purpose of the present invention, as embodied and broadly described, a method of transmitting a resource allocation information by a base station in a wireless communication system, may include transmitting E-PDCCH (enhanced-physical downlink control channel) including a downlink (DL) grant on a specific resource region to a user equipment, wherein the E-PDCCH includes a resource allocation (RA) field of a DCI format, wherein a 1^{st} indication value of the RA field indicates that PDSCH (physical downlink shared channel) is transmitted on the rest of the specific resource region except a DL grant region and wherein a 2^{nd} indication value of the RA field indicates that the rest of the specific resource region except the DL grant region and a UL grant region existing in the specific resource region. Preferably, the specific resource region may include a region configured by RBG (resource block group) or RB (resource block) unit. Preferably, the DL grant may be transmitted by a unit of one of RBG (Resource Block Group), RB (Resource Block), slot, symbol, RE (Resource Element), eREG (enhanced Resource ElementG), eCCE (enhanced Control Channel Element) and combination thereof. Preferably, a location of the UL grant may include a pre-designated location or is determined by the DL grant. More preferably, if the location of the UL grant is determined by the DL grant, the location of the UL grant may be determined based on one of indexes of RBG (Resource Block Group), RB (Resource Block), slot, symbol, RE (Resource Element), eREG (enhanced Resource ElementG) and eCCE (enhanced Control Channel Element), on which the DL grant is received.

To achieve another technical task and in accordance with the purpose of the present invention, as embodied and broadly described, a user equipment of receiving a resource allocation information in a wireless communication system may include a receiver configured to receive E-PDCCH (enhanced-physical downlink control channel) including a downlink (DL) grant on a specific resource region from a base station and a processor configured to decode a resource allocation (RA) field of a DCI format of the received E-PDCCH, the processor determining whether PDSCH (physical downlink shared channel) is transmitted on the rest of the specific resource region except a DL grant region or the rest of the specific resource region except the DL grant region and a UL grant region existing in the specific resource region depending on a result of the decoded RA field. Preferably, a location of the UL grant may include a pre-designated location or is determined by the DL grant. More preferably, if the location of the UL grant is determined by the DL grant, the processor may obtain the location of the UL grant based on one of indexes of RBG (Resource Block Group), RB (Resource Block), slot, symbol, RE (Resource Element), eREG (enhanced Resource ElementG) and eCCE (enhanced Control Channel Element), on which the DL grant is received.

To achieve another technical task and in accordance with the purpose of the present invention, as embodied and broadly described, a base station of transmitting a resource allocation information in a wireless communication system may include a transmitter configured to transmit E-PDCCH (enhanced-physical downlink control channel) including a downlink (DL) grant on a specific resource region to a user equipment, wherein the E-PDCCH includes a resource allocation (RA) field of a DCI format, wherein a first indication value of the RA field indicates that PDSCH (physical downlink shared channel) is transmitted on the rest of the specific resource region except a DL grant region and wherein a second indication value of the RA field indicates that the rest of the specific resource region except the DL grant region and a UL grant region existing in the specific resource region. Preferably, the specific resource region may include a region configured by RBG (resource block group) or RB (resource block) unit. More preferably, the DL grant may be transmitted by a unit of one of RBG (Resource Block Group), RB (Resource Block), slot, symbol, RE (Resource Element), eREG (enhanced Resource ElementG), eCCE (enhanced Control Channel Element) and combination thereof.

### Advantageous Effects

According to various embodiments of the present invention, a base station transmits resource allocation information to a user equipment in an implicit manner and the user equipment then obtains the resource allocation information in the implicit manner. Thus, it is unnecessary to deliver the resource allocation information by separate signaling. Therefore, the present invention can considerably reduce signaling overhead and the like.

As the user equipment obtains the resource allocation information in the implicit manner, the present invention considerably reduces overhead due to unnecessary signaling decoding, thereby enhancing communication performance.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic diagram of E-UMTS network structure as an example of a wireless communication system.

FIG. 2 is a block diagram for configurations of a base station 205 and a user equipment 210 in a wireless communication system 200.

FIG. 3 is a diagram for one example of a radio frame used in a 3GPP LTE/LTE-A system as one example of a wireless communication system.

FIG. 4 is a diagram for one example of a resource grid of a downlink slot in a 3GPP LTE/LTE-A system as one example of a wireless communication system.

FIG. 5 is a diagram for one example of a structure of a downlink subframe in a 3GPP LTE/LTE-A system as one example of a wireless communication system.

FIG. 6 is a diagram for one example of a structure of an uplink subframe in a 3GPP LTE/LTE-A system as one example of a wireless communication system.

FIG. 7 is a diagram for one example of a CA (carrier aggregation) communication system.

FIGS. 8A to 8C are diagrams of RE (resource elements) used for UE-specific reference signals in case of using normal CP for antenna ports 7, 8, 9 and 10.

FIG. 9A and FIG. 9B are diagrams of RE (resource elements) used for UE-specific reference signals in case of using extended CP for antenna ports 7, 8, 9 and 10.

FIG. 10A is a diagram of the symbol numbers of DwPTS, GP and UpPTS in accordance with special subframe configuration indexes and FIGS. 10B to 10D are diagrams of DL/UL grant search space configurations in special subframes, respectively.

FIG. 11A and FIG. 11B are diagrams for examples to describe a method for a base station to indicate an implicit resource assignment to a user equipment.

FIG. 12A shows an implicit resource assignment scheme in case that RA bit indicates 1, when E-PDCCH (enhanced physical downlink control channel) is transmitted with PDSCH by having a TDM (time division multiplexing) & FDM (frequency division multiplexing) mixed scheme applied thereto. FIG. 12B shows an implicit resource assignment scheme in case that RA bit indicates 0, when E-PDCCH (enhanced physical downlink control channel) is transmitted with PDSCH by having a TDM (time division multiplexing) & FDM (frequency division multiplexing) mixed scheme applied thereto.

FIG. 13A shows an implicit resource assignment scheme in case that RA bit indicates 1, when E-PDCCH (enhanced physical downlink control channel) is transmitted by FDM (frequency division multiplexing) scheme. FIG. 13B shows an implicit resource assignment scheme in case that RA bit indicates 0, when E-PDCCH (enhanced physical downlink control channel) is transmitted by FDM (frequency division multiplexing) scheme. And, the former implicit resource assignment schemes described with reference to FIG. 12A and FIG. 12B can be exactly applied thereto.

FIG. 14A and FIG. 14B show implicit resource assignment schemes in case that RA bit indicates 0, when E-PDCCH (enhanced physical downlink control channel) is transmitted with PDSCH by having a TDM (time division multiplexing) & FDM (frequency division multiplexing) mixed scheme applied thereto, respectively.

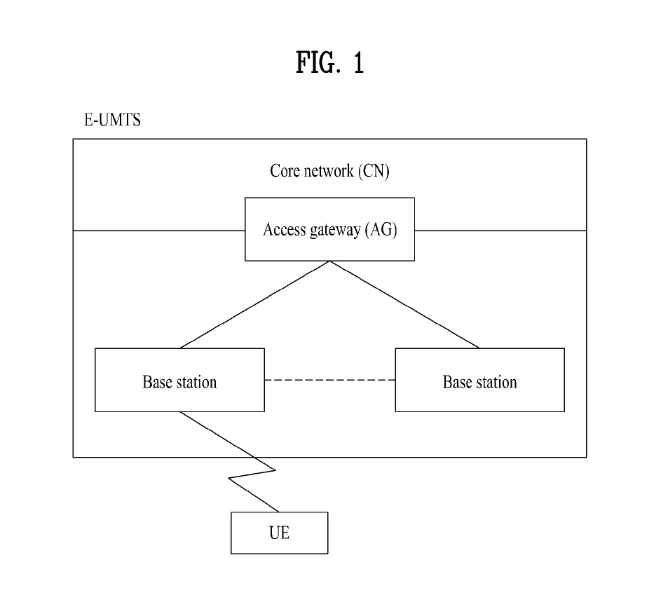

### BEST MODE

### Mode for Invention

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. For instance, although the following descriptions are made in detail on the assumption that a mobile communication system includes IEEE (institute of electrical and electronics engineers) 802.16 system or 3GPP (3^{rd} generation partnership project) system, they are applicable to other random mobile communication systems except unique features of IEEE 802.16 system or 3GPP system.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS), and the like. And, assume that a base station is a common name of such a random node of a network stage communicating with a terminal as a Node B, an eNode B, a base station (BS), an access point (AP) and the like.

In a mobile communication system, a user equipment may be able to receive information in downlink from a base station and transmit information in uplink to the base station. The informations transmitted or received by the user equipment may include data and various control informations. And, various kinds of physical channels may exist in accordance with types and usages of the informations transmitted or received by the user equipment.

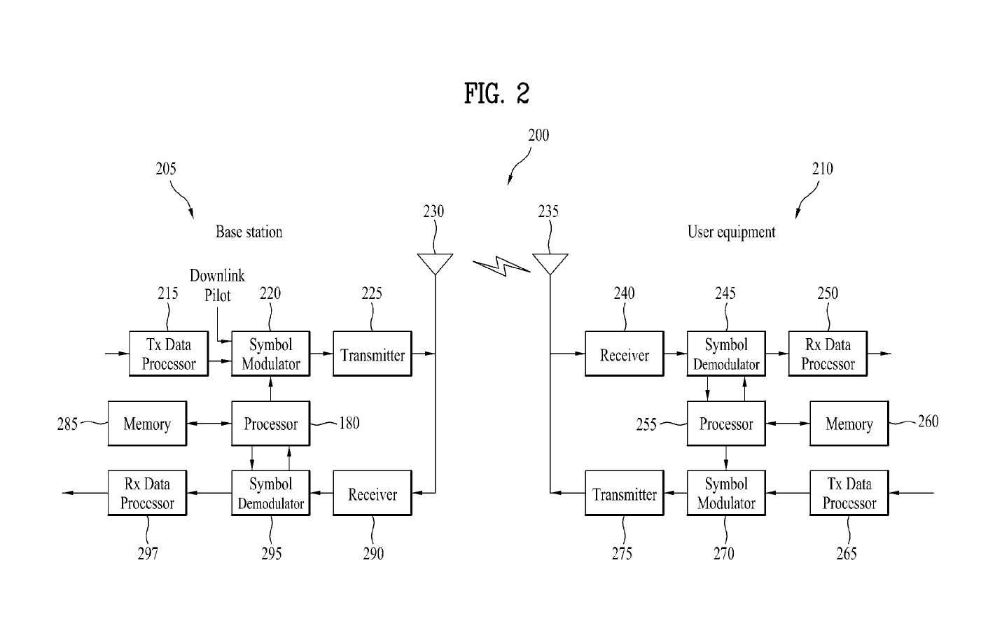

FIG. 2 is a block diagram for configurations of an base station 205 and a user equipment 210 in a wireless communication system 200.

Although one base station 205 and one user equipment 210 are shown in the drawing to schematically represent a wireless communication system 200, the wireless communication system 200 may include at least one base station and/or at least one user equipment.

Referring to FIG. 2, a base station 205 may include a transmitted (Tx) data processor 215, a symbol modulator 220, a transmitter 225, a transceiving antenna 230, a processor 280, a memory 285, a receiver 290, a symbol demodulator 295 and a received data processor 297. And, a user equipment 210 may include a transmitted (Tx) data processor 265, a symbol modulator 275, a transmitter 275, a transceiving antenna 235, a processor 255, a memory 260, a receiver 240, a symbol demodulator 255 and a received data processor 250. Although the base station/user equipment 205/210 includes one antenna 230/235 shown in the drawing, each of the base station 205 and the user equipment 210 includes a plurality of antennas. Therefore, each of the base station 205 and the user equipment 210 according to the present invention supports an MIMO (multiple input multiple output) system. And, the base station 205 according to the present invention may support both SU-MIMO (single user-MIMO) and MU-MIMO (multi user-MIMO) systems.

In downlink, the transmitted data processor 215 receives traffic data, performs coding on the received traffic data by formatting, interleaves the coded traffic data, modulates (or symbol maps) the interleaved data, and then provides modulated symbols (data symbols). The symbol modulator 220 provides a stream of symbols by receiving and processing the data symbols and pilot symbols.

The symbol modulator 220 multiplexes the data and pilot symbols together and then transmits the multiplexed symbols to the transmitter 225. In doing so, each of the transmitted symbols may include the data symbol, the pilot symbol or a signal value of zero (i.e., null). In each symbol duration, pilot symbols may be contiguously transmitted. In doing so, the pilot symbols may include symbols of frequency division multiplexing (FDM), orthogonal frequency division multiplexing (OFDM), time division multiplexing (TDM), or code division multiplexing (CDM).

The transmitter 225 receives the stream of the symbols, converts the received stream to at least one or more analog signals, additionally adjusts the analog signals (e.g., amplification, filtering, frequency upconverting, etc.), and then generates a downlink signal suitable for a transmission on a radio channel. Subsequently, the downlink signal is transmitted to the user equipment via the transmitting antenna 230.

In the configuration of the user equipment 210, the receiving antenna 235 receives the downlink signal from the base station and then provides the received signal to the receiver 240. The receiver 240 adjusts the received signal (e.g., filtering, amplification and frequency downconverting), digitizes the adjusted signal, and then obtains samples. The symbol demodulator 245 demodulates the received pilot symbols and then provides them to the processor 255 for channel estimation.

The symbol demodulator 245 receives a frequency response estimated value for downlink from the processor 255, obtains data symbol estimated values (i.e., estimated values of the transmitted data symbols) by performing data demodulation on the received data symbols, and then provides the data symbol estimated values to the received (Rx) data processor 250. The received data processor 250 reconstructs the transmitted traffic data by performing demodulation (i.e., symbol demapping, deinterleaving and decoding) on the data symbol estimated values.

The processing by the symbol demodulator 245 and the processing by the received data processor 250 are complementary to the processing by the symbol modulator 220 and the processing by the transmitted data processor 215 in the base station 205, respectively.

Regarding the user equipment 210 in uplink, the transmitted data processor 265 provides data symbols by processing the traffic data. The symbol modulator 270 provides a stream of symbols to the transmitter 275 by receiving the data symbols, multiplexing the received data symbols, and then performing modulation on the multiplexed symbols. The transmitter 275 generates an uplink signal by receiving the stream of the symbols and then processing the received stream. The generated uplink signal is then transmitted to the base station 205 via the transmitting antenna 235.

In the base station 205, the uplink signal is received from the user equipment 210 via the receiving antenna 230. The receiver 290 obtains samples by processing the received uplink signal. Subsequently, the symbol demodulator 295 provides pilot symbols received in uplink and a data symbol estimated value by processing the obtained samples. The received data processor 297 reconstructs the traffic data transmitted from the user equipment 210 by processing the data symbol estimated value.

The processor 255/280 of the user equipment/base station 210/205 directs operations (e.g., control, adjustment, management, etc.) of the user equipment/base station 210/205. The processor 255/280 may be connected to the memory unit 260/285 configured to store program codes and data. The memory 260/285 is connected to the processor 255/280 to store operating systems, applications and general files.

The processor 255/280 may be called one of a controller, a microcontroller, a microprocessor, a microcomputer and the like. And, the processor 255/280 may be implemented using hardware, firmware, software and/or any combinations thereof. In the implementation by hardware, the processor 255/280 may be provided with one of ASICs (application specific integrated circuits), DSPs (digital signal processors), DSPDs (digital signal processing devices), PLDs (programmable logic devices), FPGAs (field programmable gate arrays), and the like.

Meanwhile, in case of implementing the embodiments of the present invention using firmware or software, the firmware or software may be configured to include modules, procedures, and/or functions for performing the above-explained functions or operations of the present invention. And, the firmware or software configured to implement the present invention is loaded in the processor 255/280 or saved in the memory 260/285 to be driven by the processor 255/280.

Layers of a radio protocol between a user equipment 210 and an base station 205 may be classified into 1^{st} layer L1, 2^{nd} layer L2 and 3^{rd} layer L3 based on 3 lower layers of OSI (open system interconnection) model well known to communication systems. A physical layer belongs to the 1^{st} layer and provides an information transfer service via a physical channel. RRC (radio resource control) layer belongs to the 3^{rd} layer and provides control radio resources between UE and network. A user equipment and an base station may be able to exchange RRC messages with each other via a radio communication network using RRC layers.

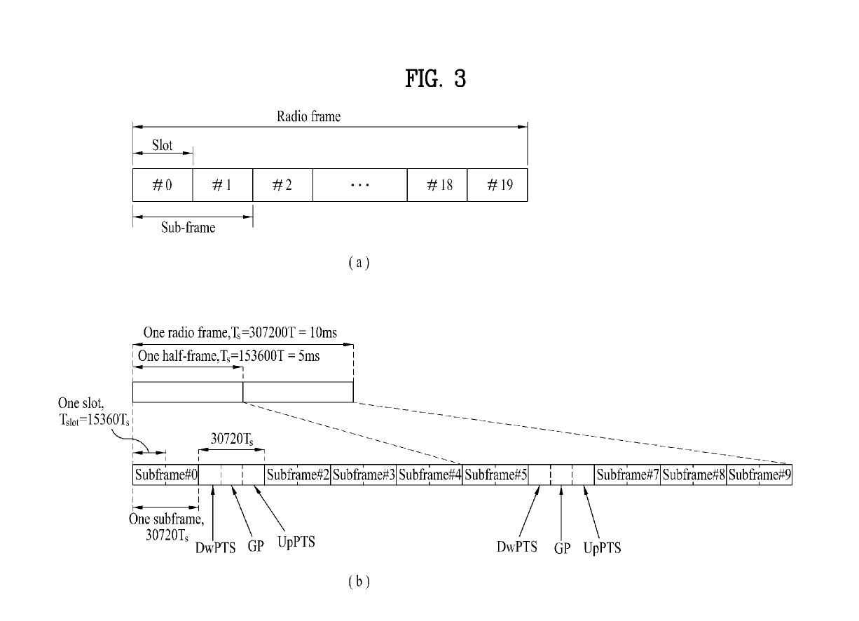

FIG. 3 shows one example of a structure of a radio frame used by a 3GPP LTE/LTE-A system for example of a wireless communication system.

In a cellular OFDM radio packet communication system, UL/DL (uplink/downlink) data packet transmission is performed by a unit of subframe. And, one subframe is defined as a predetermined time interval including a plurality of OFDM symbols. In the 3GPP LTE standard, a type-1 radio frame structure applicable to FDD (frequency division duplex) and a type-2 radio frame structure applicable to TDD (time division duplex) are supported.

FIG. 3 (a) shows one example of a structure of a radio frame of type 1. A DL (downlink) radio frame includes 10 subframes. Each of the subframes includes 2 slots. And, a time taken to transmit one subframe is defined as a transmission time interval (hereinafter abbreviated TTI). For instance, one subframe may have a length of 1 ms and one slot may have a length of 0.5 ms. One slot may include a plurality of OFDM symbols in time domain or may include a plurality of resource blocks (RBs) in frequency domain. Since 3GPP system uses OFDMA in downlink, OFDM symbol indicates one symbol duration. The OFDM symbol may be named SC-FDMA symbol or symbol duration. Resource block (RB) is a resource allocation unit and may include a plurality of contiguous subcarriers in one slot.

The number of OFDM symbols included in one slot may vary in accordance with a configuration of CP (cyclic prefix). The CP may be categorized into an extended CP and a normal CP. For instance, in case that OFDM symbols are configured by the normal CP, the number of OFDM symbols included in one slot may be 7. In case that OFDM symbols are configured by the extended CP, since a length of one OFDM symbol increases, the number of OFDM symbols included in one slot may be smaller than that of the case of the normal CP. In case of the extended CP, for instance, the number of OFDM symbols included in one slot may be 6. If a channel status is unstable (e.g., a UE is moving at high speed), it may be able to use the extended CP to further reduce the inter-symbol interference.

When a normal CP is used, since one slot includes 7 OFDM symbols, one subframe includes 14 OFDM symbols. In this case, first 2 or 3 OFDM symbols of each subframe may be allocated to PDCCH (physical downlink control channel), while the rest of the OFDM symbols are allocated to PDSCH (physical downlink shared channel).

FIG. 3 (b) shows one example of a structure of a radio frame of type 2. A type-2 radio frame includes 2 half frames. Each of the half frame includes 5 subframes, DwPTS (downlink pilot time slot), GP (guard period) and UpPTS (uplink pilot time slot). And, one of the subframes includes 2 slots. The DwPTS is used for initial cell search, synchronization or channel estimation in a user equipment. The UpPTS is used for channel estimation in a base station and uplink transmission synchronization of a user equipment. The guard period is a period for eliminating interference generated in uplink due to multi-path delay of a downlink signal between uplink and downlink.

Each half frame includes 5 subframes. A subframe denoted by ‘D’ is a subframe for a DL transmission, a subframe denoted by ‘U’ is a subframe for a UL transmission, a subframe denoted by ‘S’ is a special subframe including a downlink pilot time slot (DwPTS), a guard period (GP) and an uplink pilot time slot (UpPTS). The DwPTS is used for an initial cell search, a synchronization or a channel estimation in a user equipment. The UpPTS is used for a channel estimation in a base station and an uplink transmission synchronization of a user equipment. The guard period is a period for removing interference generated from an uplink due to a multipath delay of a DL signal between the uplink and the downlink.

In case of 5 ms DL-UL switch-point period, a special subframe S exists in every half frame. In case of 5 ms DL-UL switch-point period, it exists in a 1^{st} half frame only. Subframe indexes 0 and 5 (subframe 0 and subframe 5) and DwPTS correspond to the interval for a DL transmission only. The UpPTS and a subframe right contiguous with the special subframe always correspond to an interval for a UL transmission. If multi-cells are aggregated, a user equipment can assume the same UL-DL configuration across all cells. And, guard periods of special subframes in different cells overlap each other by 1456 Ts at least. The above-described structures of the radio frame are just exemplary. And, the number of subframes included in a radio frame, the number of slots included in the subframe and the number of symbols included in the slot may be modified in various ways.

Table 1 in the following indicates a configuration (DwPTS/GP/UpPTS) of a special frame.

TABLE 1

| | Normal cyclic prefix in downlink | | | Extended cyclic prefix in downlink | | |
|---|---|---|---|---|---|---|
| | | UpPTS | | | UpPTS | |
| | | Normal | Extended | | Normal | Extended |
| Special subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | | | |
| 8 | 24144 · Tₛ | | | | | |

Table 1 shows a special subframe configuration. Looking into the special subframe configurations 0, 1, 2, 3 and 4, the symbol numbers of DwPTS are 3, 9, 10, 11 and 12, respectively and every UpPTS has 1 symbol. Hence, the numbers of symbols usable as GP (guard period) may become 10, 4, 3, 2 and 1, respectively. In Table 2, looking into special subframe configurations 5, 6, 7 and 8, the symbol numbers of DwPTS are 3, 9, 10 and 11, respectively and every UpPTS has 2 symbols assigned thereto. Hence, the numbers of symbols usable as GP (guard period) may become 9, 3, 2 and 1, respectively. In particular, the configurations are divided into two groups depending on whether the UpPTS has one symbol or two symbols.

Table 2 shows UL-DL configuration.

TABLE 2

| Uplink-downlink | Downlink-to-Uplink | Subframe number | | | | | | | | | |
|---|---|---|---|---|---|---|---|---|---|---|---|
| configuration | Switch-point periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Referring to Table 2, in the 3GPP LTE system, there are 7 types of UL-DL configurations in the type-2 frame structure. The respective configurations may differ from each other in the numbers or locations of DL subframes, special subframes and UL subframes. In the following description, various embodiments of the present invention shall be explained based on the UL-DL configurations of the type-2 frame structure shown in Table 2.

The above-described structures of the radio frame are just exemplary. And, the number of subframes included in a radio frame, the number of slots included in the subframe and the number of symbols included in the slot may be modified in various ways.

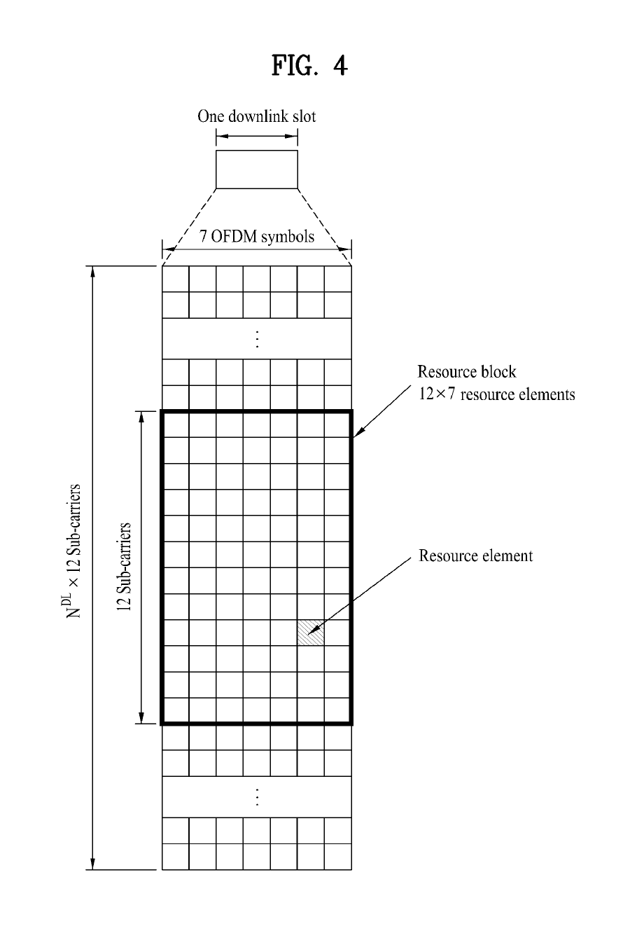

FIG. 4 is a diagram for one example of a resource grid of a downlink slot in a 3GPP LTE/LTE-A system for example of a wireless communication system.

Referring to FIG. 4, a DL slot includes a plurality of OFDM symbols in a time domain. One DL slot includes 7 (or 6) OFDM symbols and a resource block may include 12 subcarriers in a frequency domain. Each element on a resource grid is called a resource element (RE). One RB includes 12×7 or 12×6 Res. The number N_{RB} of RBs included in the DL slot depends on a DL transmission band. A structure of a UL slot is identical to that of the DL slot but OFDM symbol is replaced by SC-FDMA symbol.

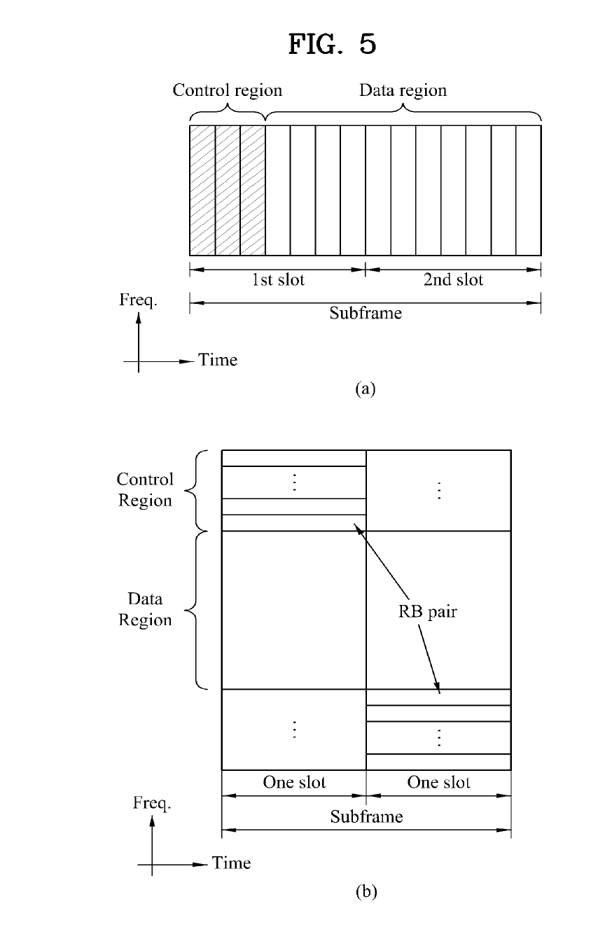

FIG. 5 shows one example of a structure of a DL subframe in a 3GPP LTE/LTE-A system for example of a wireless communication system.

Referring to FIG. 5, maximum 3 (or 4) OFDM symbols situated at a head part of a 1st slot of a subframe correspond to a control region to which a control channel is assigned. And, the rest of OFDM symbols correspond to a data region to which PDSCH (physical downlink shared channel) is assigned. For example, DL control channels used by 3GPP LTE may include PCFICH (Physical Control Format Indicator Channel), PDCCH (Physical Downlink Control Channel), PHICH (Physical hybrid ARQ indicator Channel) and the like. The PCFICH is transmitted on a 1st OFDM symbol of a subframe and carries information on the number of OFDM symbols used for a control channel transmission in the subframe. The PHICH carries HARQ ACK/NACK (acknowledgment/negative-acknowledgment) signal in response to a UL transmission.

Control information transmitted on PDCCH is called DCI (downlink control information). Regarding DCI formats, Format 0 is defined for uplink and Format 1, Format 1A, Format 1B, Format 1C, Format 1D, Format 2, Format 2A, Format 3, Format 3A and the like are defined for downlink. Depending on usages, DCI format selectively includes such information as hopping flag, RB assignment, MCS (modulation coding scheme), RV (redundancy version), NDI (new data indicator), TPC (transmit power control), cyclic shift DM RS (demodulation reference signal), CQI (channel quality information) request, HARQ process number, TPMI (transmitted precoding matrix indicator), PMI (precoding matrix indicator) confirmation and the like.

PDCCH carries transmission format and resource allocation information of DL-SCH (downlink shared channel), transmission format and resource allocation information of UL-SCH (uplink shared channel), paging information on PCH (paging channel), system information on DL-SCH, resource allocation information of an upper-layer control message such as a random access response transmitted on PDSCH, Tx power control command set for individual user equipments within a user equipment group, Tx power control command, activation indication information of VoIP (voice over IP) and the like. A plurality of PDCCHs may be transmitted in a control region. A user equipment can monitor a plurality of PDCCHs. PDCCH is transmitted on aggregation of at least one or more contiguous CCEs (control channel elements). In this case, the CCE is a logical assignment unit used to provide PDCCH with a coding rate based on a radio channel state. The CCE corresponds to a plurality of REGs (resource element groups). PDCCH format and the number of PDCCH bits are determined depending on the number of CCEs. A base station determines PDCCH format in accordance with DCI to transmit to a user equipment and attaches CRC (cyclic redundancy check) to control information. The CRC is masked with an identifier (e.g., RNTI (radio network temporary identifier)) in accordance with an owner or a purpose of use. For instance, if PDCCH is provided for a specific user equipment, CRC may be masked with an identifier (e.g., C-RNTI (cell-RNTI)) of the corresponding user equipment. If PDCCH is provided for a paging message, CRC may be masked with a paging identifier (e.g., P-RNTI (paging-RNTI)). If PDCCH is provided for system information (particularly, SIC (system information block)), CRC may be masked with SI-RNTI (system information-RNTI). And, if PDCCH is provided for a random access response, CRC may be masked with RA-RNTI (random access-RNTI).

PDCCH can carry resource allocation and transmission format (this is so-called DL grant) of PDSCH, resource allocation information (this is so-called UL grant) of a physical UL shared channel, an aggregation of transmission power control commands for a random user equipment and individual user equipments in a group, activation of VoIP (voice over internet protocol) and the like. A plurality of PDCCHs may be transmitted within a control region and a user equipment can monitor a plurality of the PDCCHs. The PDCCH is constructed with aggregation of one or several contiguous CCEs (control channel elements). The PDCCH constructed with the aggregation of one or several CCEs may be transmitted via the control region after completion of subblock interleaving. The CCE is a logical allocation unit used to provide the PDCCH with a coding rate in accordance with a status of a radio channel. The CCE corresponds to a plurality of resource element groups. The format of the PDCCH and the bit number of available PDCCH are determined in accordance with the correlation between the number of CCEs and the coding rate provided by the CCEs.

The control information carried on the PDCCH may be called DL control information (hereinafter abbreviated DCI). Table 1 shows the DCI according to DCI format.

TABLE 3

| DCI Format | Description |
|---|---|
| DCI format 0 | used for the scheduling of PUSCH |
| DCI format 1 | used for the scheduling of one PDSCH codeword |
| DCI format 1A | used for the compact scheduling of one PDSCH |
| | codeword and random access procedure initiated |
| | by a PDCCH order |
| DCI format 1B | used for the compact scheduling of one PDSCH |
| | codeword with precoding information |
| DCI format 1C | used for very compact scheduling of one PDSCH |
| | codeword |
| DCI format 1D | used for the compact scheduling of one PDSCH |
| | codeword with precoding and power offset |
| | information |
| DCI format 2 | used for scheduling PDSCH to UEs configured in |
| | closed-loop spatial multiplexing mode |
| DCI format 2A | used for scheduling PDSCH to UEs configured in |
| | open-loop spatial multiplexing mode |
| DCI format 3 | used for the transmission of TPC commands for |
| | PUCCH and PUSCH with 2-bit power adjustments |
| DCI format 3A | used for the transmission of TPC commands for |
| | PUCCH and PUSCH with single bit power adjustments |

DCI format 0 indicates UL resource allocation information, DCI format 1˜2 indicates DL resource allocation information, and DCI format 3 or 3A indicates a transmission power control (hereinafter abbreviated TPC) command for random UE groups.

Generally, a base station can transmit scheduling allocation information and other control informations via PDCCH. A physical control channel may be transmitted as one aggregation or a plurality of contiguous control channel elements (CCEs). In this case, one control channel element (hereinafter abbreviated CCE) includes 9 resource element groups (REGs). The number of REGs failing to be allocated to PCFICH (physical control format indicator channel) or PHICH (physical hybrid automatic repeat request indicator channel) is N_{REG}. The number of CCEs available for a system ranges 0 to ‘N_{CCE}−1’, where N_{REG}=└N_{REG}/9┘. The PDCCH supports such a multiple format as shown in Table 4. One PDCCH including n contiguous CCEs starts with a CCE that executes ‘i mod n=0’, where ‘i’ is a CCE number. Multiple PDCCHs may be transmitted in one subframe.

TABLE 4

| PDCCH | Number of | Number of resource- | Number of |
|---|---|---|---|
| format | CCEs | element groups | PDCCH bits |
| 0 | 1 | 9 | 72 |
| 1 | 2 | 18 | 144 |
| 2 | 4 | 36 | 288 |
| 3 | 8 | 72 | 576 |

Referring to Table 4, a base station is able to determine a PDCCH format in accordance with how many regions will receive control information and the like. And, a user equipment is able to reduce overhead by reading the control information and the like by CCE unit.

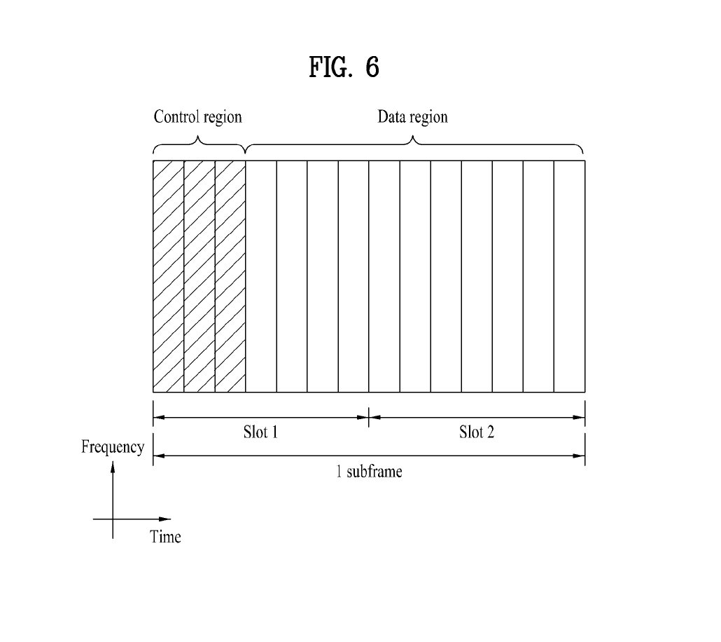

FIG. 6 shows one example of a structure of a UL subframe used by a 3GPP LTE/LTE-A system for example of a wireless communication system.

Referring to FIG. 6, a UL subframe includes a plurality of slots (e.g., 2 slots). Each of the slots can include SC-FDMA symbols of which number varies in accordance with a CP length. The UL subframe is divided into a data region and a control region in a frequency domain. The data region includes PUSCH and is used to transmit such a data signal as audio and the like. The control region includes PUCCH and is used to transmit uplink control information (UCI). The PUCCH includes an RB pair situated at both end portions of the data region on a frequency axis and hops using a slot as a boundary.

PUCCH can be used to transmit the following control information.
SR (scheduling request): this is information used to request an uplink UL-SCH resource. This is transmitted by OOK (on-off keying).
HARQ ACK/NACK: This is a response signal for a DL data packet on PDSCH. This indicates whether the DL data packet is successfully received. In response to a single DL codeword, 1-bit ACK/NACK is transmitted. In response to two DL codewords, 2-bit ACK-NACK is transmitted.
CQI (channel quality indicator): This is the feedback information on a DL channel. MIMO (multiple input multiple output) related feedback information includes RI (rank indicator), PMI (precoding matrix indicator), PTI (precoding type indicator) and the like. 20 bits are used per subframe.

A size of control information (UCI) transmittable in a subframe by a user equipment depends on the number of SC-FDMAs available for a control information transmission. The SC-FDMA available for the control information transmission means SC-FDMA symbol remaining after excluding SC-FDMA symbol for a reference signal transmission from a subframe. In case of an SRS (sounding reference signal) configured subframe, a last SC-FDMA symbol of the subframe is excluded as well. A reference signal is used for coherent detection of PUCCH. And, the PUCCH supports 7 formats depending on transmitted informations.

Table 5 shows a mapping relationship between PUCCH format and UCI in LTE.

TABLE 5

| PUCCH format | Uplink Control Information (UCI) |
|---|---|
| Format 1 | SR(Scheduling Request) (non-modulated waveform) |
| Format 1a | 1-bit HARQ ACK/NACK (SR presence/non-presence) |
| Format 1b | 2-bit HARQ ACK/NACK (SR presence/non-presence) |
| Format 2 | CQI (20 coded bits) |
| Format 2 | CQI & 1- or 2-bit HARQ ACK/NACK (20 bits) |
| | (corresponding to an extended CP only) |
| Format 2a | CQI & 1-bit HARQ ACK/NACK ((20 + 1) coded bits) |
| Format 2b | CQI & 2-bit HARQ ACK/NACK ((20 + 2) coded bits) |

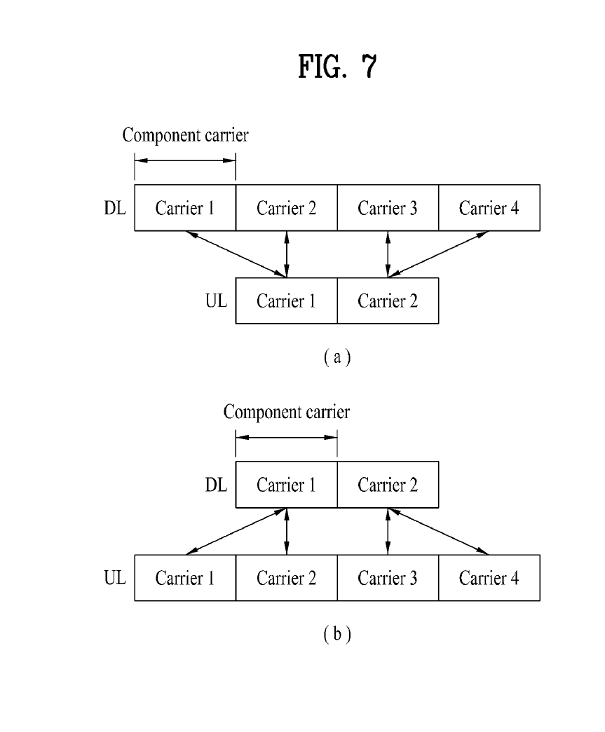

FIG. 7 is a diagram for one example of a CA (carrier aggregation) system in a 3GPP LTE/LTE-A system as one example of a wireless communication system.

LTE-A system uses the carrier aggregation (or bandwidth aggregation) scheme that uses a wider UL/DL bandwidth by aggregating a plurality of IL/DL frequency bandwidths for a wider frequency bandwidth. Each of the smaller frequency bandwidths is transmitted using a component carrier (CC). The component carrier may be understood as a carrier frequency (e.g., a center carrier, a center frequency) for a corresponding frequency block.

Component carriers (CCs) can be configured contiguous or non-contiguous with each other in a frequency domain. A bandwidth of the CC may be limited to a bandwidth used by a legacy system to secure backward compatibility with the legacy system. For instance, a legacy 3GPP LTE system supports bandwidths of {1.4, 3, 5, 10, 15, 20} MHz but a 3GPP LTE-advanced (LTE-A) system can support bandwidths greater than 20 MHz using the above bandwidths supported by LTE only. A bandwidth of each component carrier (CC) can be independently determined. And, it is possible to configure asymmetric carrier aggregation in which the number of UL CCs and the number of DL CCs are different from each other. DL/UL CC is configured to be fixed to a system or may be configured semi-statically. For instance, referring to FIG. 7 (a), if there are 4 DL CCs and 2 UL CCs, it is possible to configure a DL-UL linkage in a manner of DL CC:UL CC=2:1. Similarly, referring to FIG. 7 (b), if there are 2 DL CCs and 4 UL CCs, it is possible to configure a DL-UL linkage in a manner of DL CC:UL CC=1:2. Unlike the drawing, it is possible to configure a symmetric carrier aggregation in which the number of UL CCs and the number of DL CCs are equal to each other. In this case, it is possible to configure a DL-UL linkage in a manner of DL CC:UL CC=1:1.

Although a total system bandwidth is configured with N component carriers (CCs), a frequency band, which can be monitored/received by a specific user equipment, may be limited to M (<N) CCs. Various parameters for carrier aggregation can be configured cell-specific, UE group-specific or UE-specific. Meanwhile, control information may be configured transmittable/receivable through a specific CC only. In this case, the specific CC may be named a primary CC (PCC) and the rest of CCs may be named secondary CCs (SCCs).

LTE-A uses the concept of cell to manage radio resources. The cell may be defined as the combination of DL resource and UL resource. And, the UL resource may not be mandatory. Hence, the cell may include DL resource only or may include DL resource and UL resource. In case that carrier aggregation is supported, a linkage between a carrier frequency (or DL CC) of DL resource and a carrier frequency (or UL CC) of UL resource may be indicated by system information. A cell operating on a primary frequency (or PCC) may be named a primary cell (PCell) and a cell operating on a secondary frequency (or SCC) may be named a secondary cell (SCell).

The PCell is used by a user equipment to perform an initial connection establishment process or a connection re-establishment process. The PCell may mean the cell indicated in a handover process. The SCell may be configured after completion of RRC connection configuration and may be used to provide an additional radio resource. The PCell and the SCell may be generally called a serving cell. Hence, although a user equipment is in RRC_CONNECTED state, if the user equipment fails in configuring or supporting carrier aggregation, there exists one serving cell including PCell only. On the other hand, when a user equipment is in RRC_CONNECTED state, if the user equipment successfully configures the carrier aggregation, at least one serving cell exists. And, one PCell and all SCells are included in a whole serving cell. For the carrier aggregation, after an initial security activation process has been initiated, a network can configure at least one SCell in addition to PCell, which has been configured in an early stage of a connection establishment process, for a user equipment supportive of the carrier aggregation.

Unlike the existing LTE system that uses a single carrier, carrier aggregation uses a multitude of component carriers (CC) and needs a method of managing the component carriers effectively. In order to effectively manage component carriers, the component carriers can be sorted by roles and features. In carrier aggregation, multicarrier can be divided into a primary component carrier (PCC) and a secondary component carrier (SCC), which may be UE-specific parameters.

The primary component carrier (PCC) is the component carrier that becomes a center of component carrier management when several component carriers are used. And, one primary component carrier (PCC) is defined for each user equipment. The primary component carrier can play a role as a core carrier that manages all component carriers. And, the rest of the secondary component carriers can play a role in providing an additional frequency resource to provide a high data rate. For instance, an base station is able to establish a connection (RRC) for signaling with a user equipment using the primary component carrier. Providing information for security and higher layers can be achieved using the primary component carrier as well. Actually, in case that one component carrier exists only, the corresponding component carrier may become a primary component carrier. In this case, the corresponding component carrier may be responsible for the same role of a carrier of the legacy LTE system.

The base station is able to assign an activated component carrier (hereinafter abbreviated ACC) among a plurality of component carriers to the user equipment. The user equipment is already aware of the activated component carrier (ACC) assigned to itself. The user equipment gathers responses to a plurality of PDCCHs received from DL PCell and DL SCell and is then able to transmit the gathered responses on PUCCH via UL PCell.

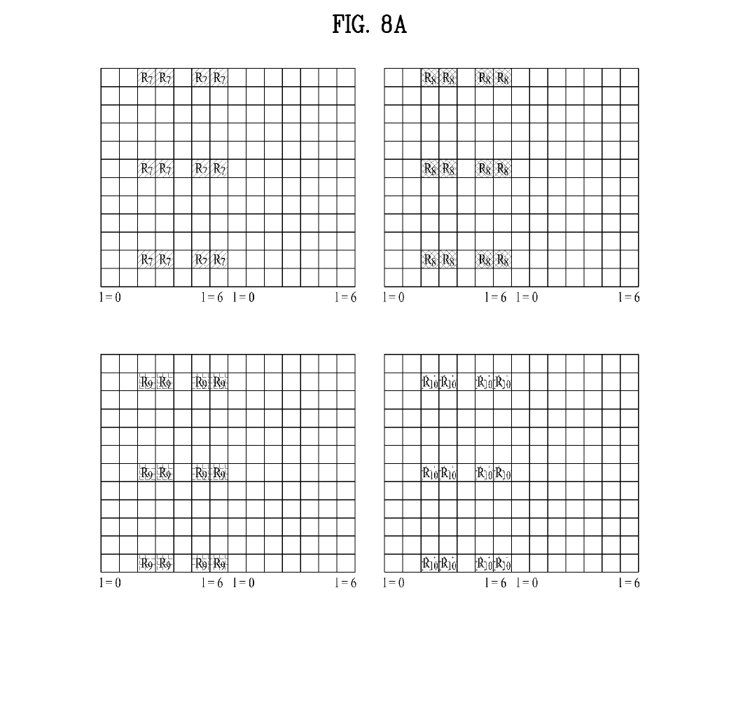

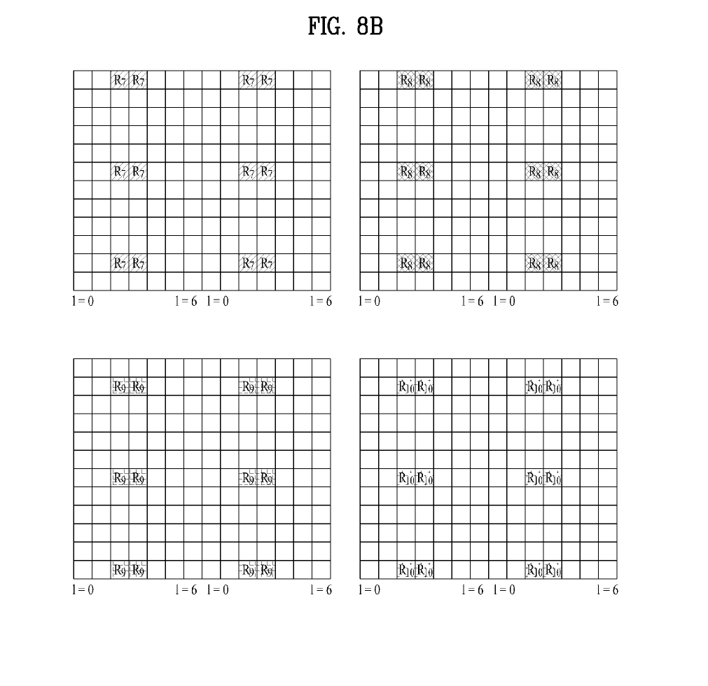

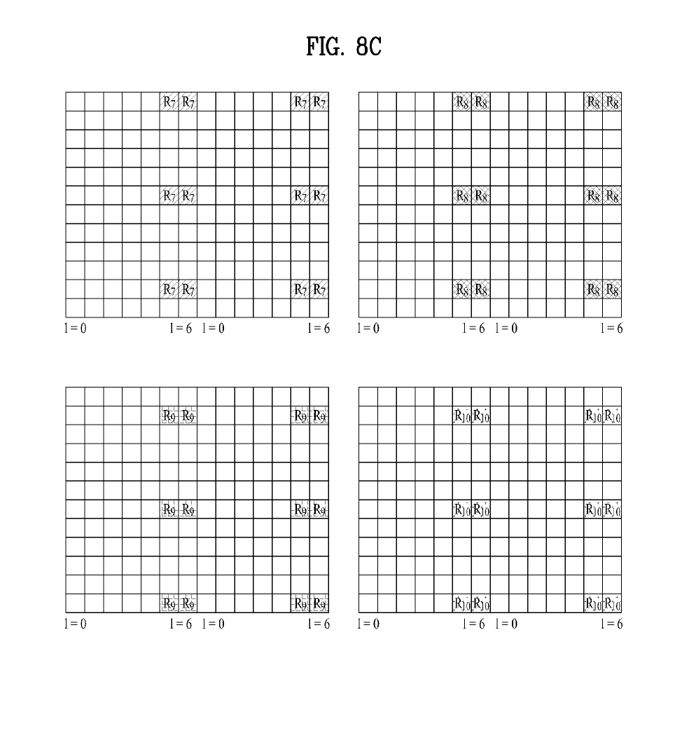

FIGS. 8A to 8C are diagrams of RE (resource elements) used for UE-specific reference signals in case of using normal CP for antenna ports 7, 8, 9 and 10. FIG. 8A shows RS RE configurations for special subframe configurations 1, 2, 6 and 7, respectively. FIG. 8B shows RS RE configurations for special subframe configurations 3, 4 and 8, respectively. FIG. 8C shows RS RE configurations for the rest of DL subframes. In FIGS. 8A to 8C, a horizontal axis indicates a time domain (e.g., 14 OFDM symbols), a vertical axis indicates a frequency domain (e.g., 1w subcarriers), and each lattice indicates RE.

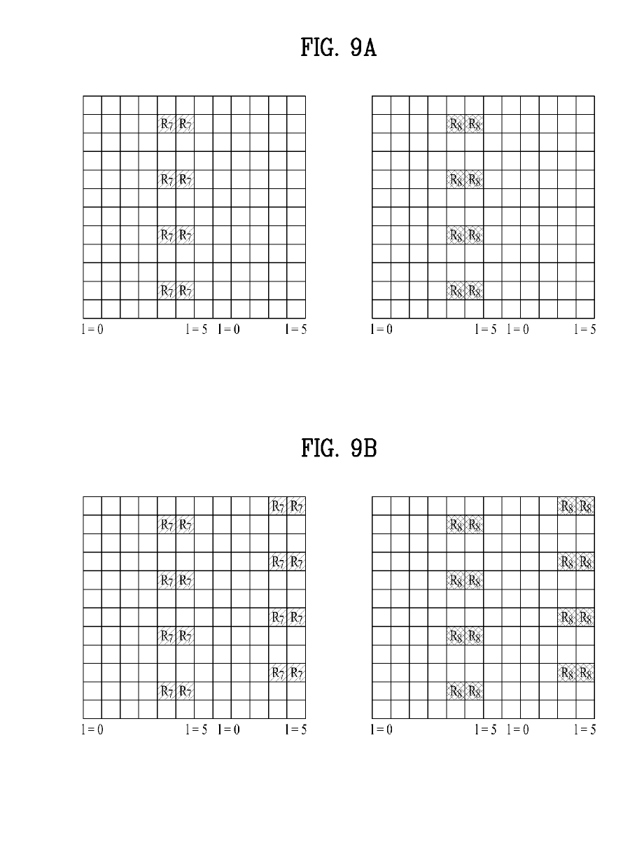

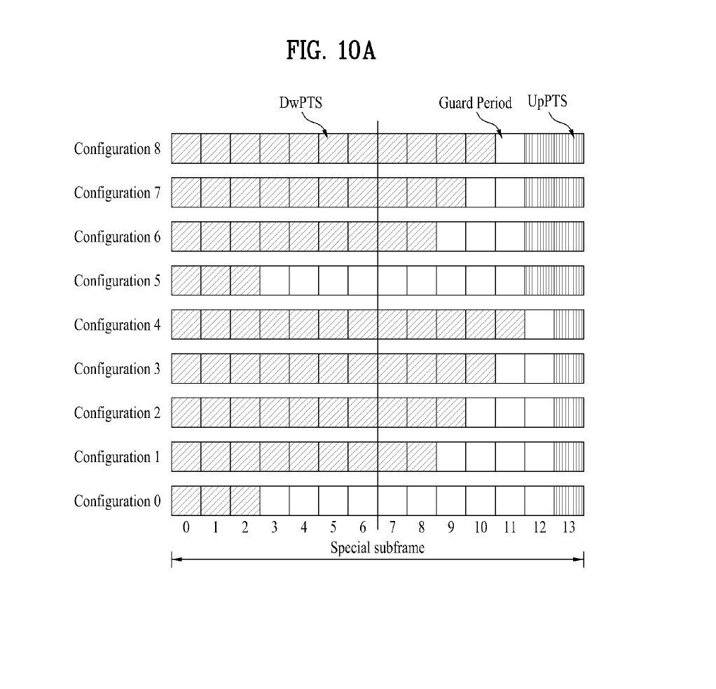

FIG. 9A and FIG. 9B are diagrams of RE (resource elements) used for UE-specific reference signals in case of using extended CP for antenna ports 7, 8, 9 and 10. FIG. 9A shows RS RE configurations for special subframe configurations 1, 2, 3, 5 and 6, respectively. FIG. 9B shows RS RE configurations for the rest of DL subframes. Likewise, in FIG. 9A and FIG. 9B, a horizontal axis indicates a time domain (e.g., 14 OFDM symbols), a vertical axis indicates a frequency domain (e.g., 1w subcarriers), and each lattice indicates RE.

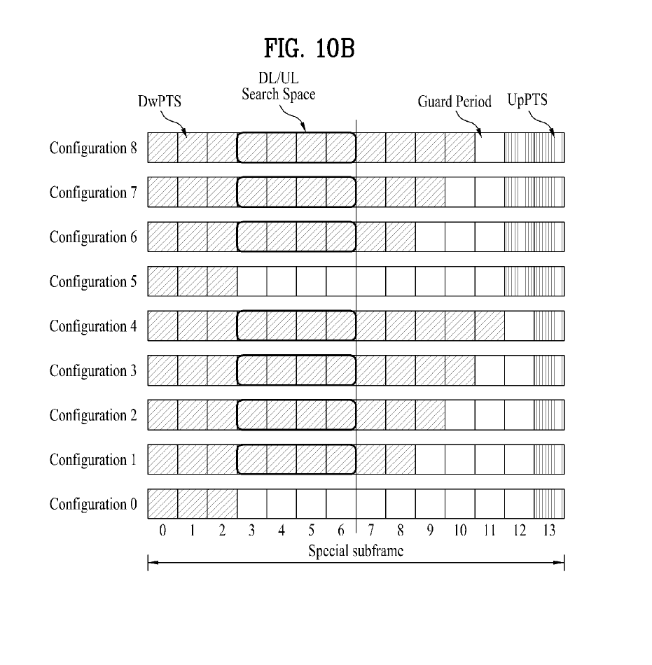

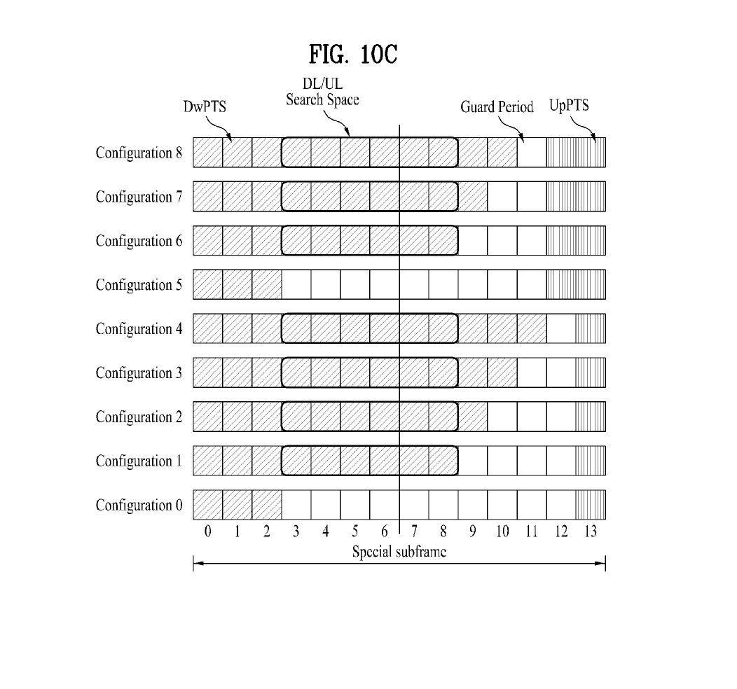

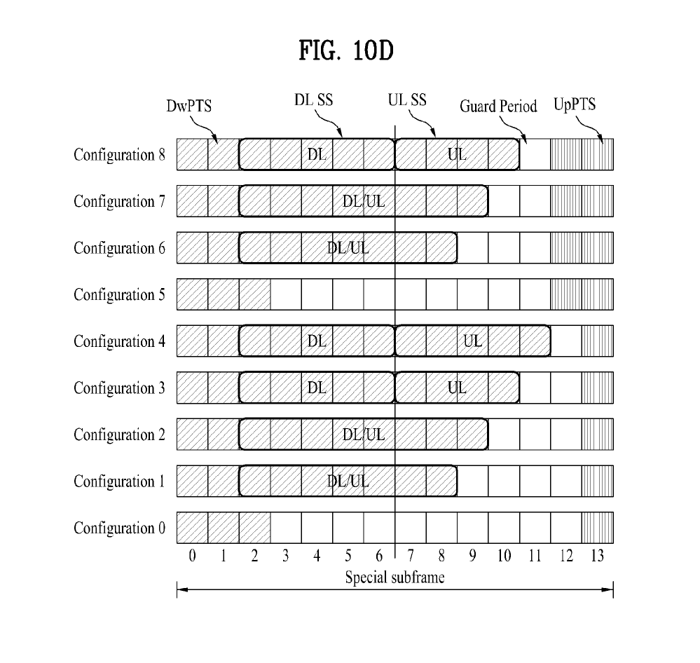

FIG. 10A is a diagram of the symbol numbers of DwPTS, GP and UpPTS in accordance with special subframe configuration indexes and FIGS. 10B to 10D are diagrams of DL/UL grant search space configurations in special subframes, respectively.

Referring to FIG. 10A, it can be observed that the number of symbols usable for DwPTS varies in a second slot depending on each special subframe configuration. Since the DwPTS includes one symbol only in each of the special subframe configuration 0 and the special subframe configuration 5, it may be difficult to be used for a backhaul transmission. In case of the special subframe configurations 1, 2, 3, 4, 6, 7 and 8, since a first slot is usable for all, transmissions of R-PDCCH (relay physical downlink control channel) DL grant and E-PDCCH DL grant. Yet, since the number of symbols of the second slot is 2, 3 or 4, it is inappropriate for transmitting UL grant. Of course, it is able to transmit the UL grant by assigning more RBs. Yet, since it may result in not using RB resources efficiently, it is not preferable.

To solve this problem, there is a simple method of transmitting a UL grant as well as DL grant in a first slot. In particular, referring to FIG. 10B, a UL grant search space is situated in the first slot. Alternatively, referring to FIG. 10C, it is possible to configure a DL/UL search space by having a 2^{nd} symbol of the second slot included as a search space. In the example shown in FIG. 10D, a search space starts with a 3^{rd} symbol in consideration of DM RS RE position. In case of the configurations 3, 4 and 8, in which DM RS RE is situated in the first slot and the second slot, DL/UL space is configured in a manner of being separated. On the contrary, in case of configurations 1, 2, 6 and 7, in which DM RS RE is situated in the first slot only, a search space having DM RS RE included in the first slot is configured and the configured search space is proposed as configuring a DL/UL common search space.

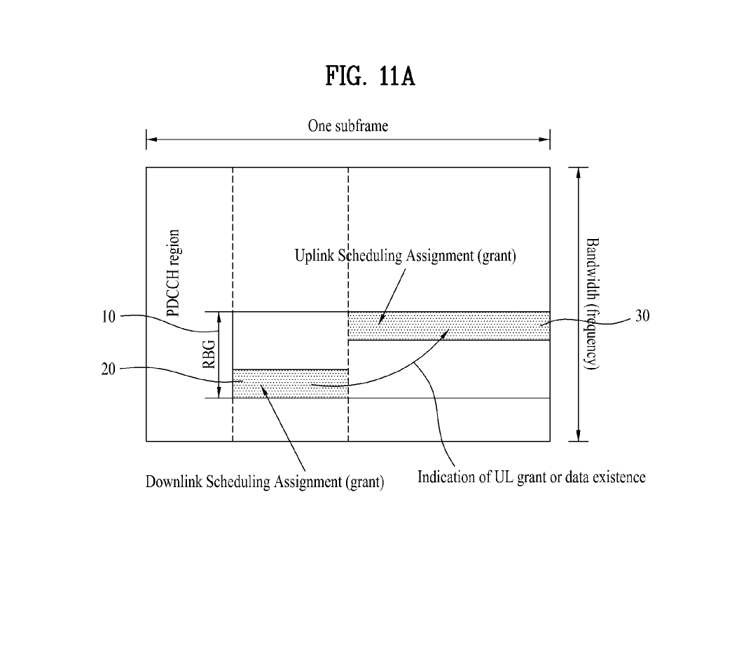

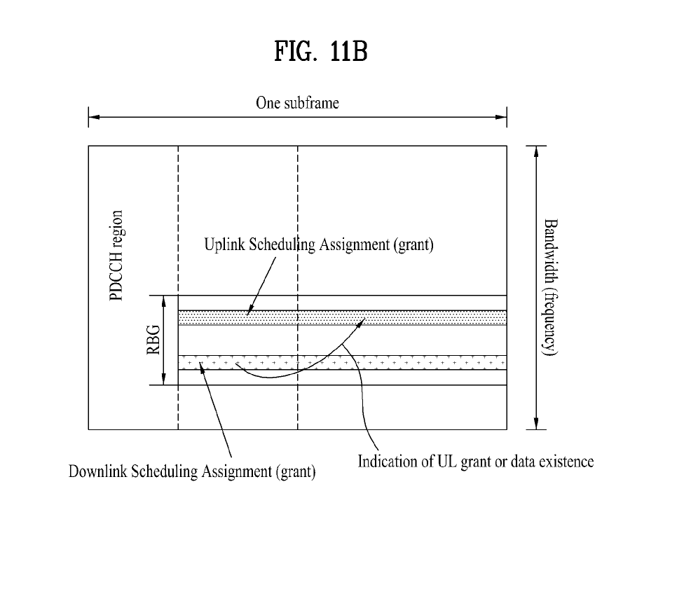

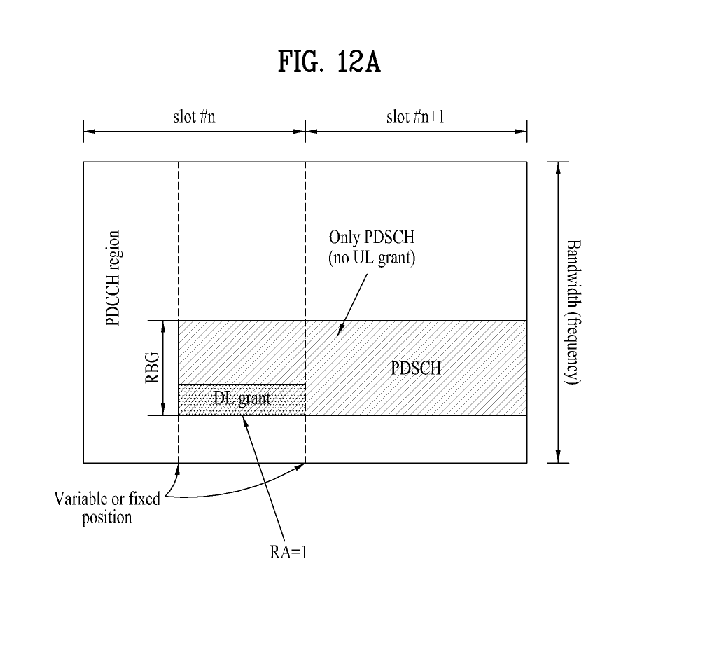

FIG. 11A and FIG. 11B are diagrams for examples to describe a method for a base station to indicate an implicit resource assignment to a user equipment. In particular, FIG. 11A shows that E-PDCCH (enhanced physical downlink control channel) is transmitted with PDSCH by having a TDM (time division multiplexing) & FDM (frequency division multiplexing) mixed scheme applied thereto. And, FIG. 11B shows that E-PDCCH is transmitted with PDSCH by FDM scheme.

FIG. 11A shows one embodiment to describe how to indicate an implicit resource allocation in case of using RA (resource allocation) Type 0 (e.g., RBG (resource block group) unit resource allocation type). In association with E-PDCCH introduced LTE-A system, the present invention newly proposes the concepts of enhanced REG (eREG) and enhanced CCE (eCCE). For example, 1 PRB is proposed to correspond to 8 eREG or 6 eREG, which is a resource region corresponding to 3 eCCE or 4 eCCE.

For clarity, FIG. 11A shows RBG unit resource allocation and the description is made in accordance with RBG unit resource allocation, by which the present invention may be non-limited. For instance, resource allocation can be performed by RB unit. If a DL grant is detected from a 1^{st} slot (slot 1) of a given RBG 10 by a user equipment and an RA field of DCI format indicates that PDSCH is assigned to the corresponding RBG 10 (e.g., if RA=1), proposed is a method of interpreting that the user equipment performs demodulation on the assumption that the PDSCH (e.g., data) is transmitted on the rest of the corresponding RBG 10 except a DL grant region 20.

On the contrary, if RA=0, it indicates that ‘UL grant is present at a previously designated location in RBG or several RBG bundles and the rest of regions except the regions occupied by DL grant and UL grant are transmitted by being filled with PDSCH’. Hence, the present invention proposes a method of setting a user equipment to interpret such a meaning in advance.

In this case, a location 30 of the UL grant may include one of a previously designated location, a location directly indicated by the DL grant and a location found by a method of implicitly enabling a user equipment to find out where the UL grant is located in accordance with an RA bit field and a location of a DL grant. A detailed location of the UL grant may exist in the first slot or the second slot or across the two slots. Alternatively, the phases of UL grant configured by subcarrier unit (e.g., 6 subcarriers) are included all. Moreover, UL grant location configured with combination of subcarrier and OFDM symbol is included as well.

Moreover, although the DL grant region 20 is represented as a centralized region in FIG. 11A or FIG. 11B, the DL grant can be transmitted on a region distributed as eREG, eCCE unit (or bundle) or the like as well as the aforementioned RBG, RB or slot symbol unit. In this case, an index of the DL grant detected RBG, RB, slot, symbol, RE, eREG or eCCE unit (or bundle) can implicitly indicate whether the UL grant or the PDSCH is transmitted on the region except the DL grant region 20. Hence, a user equipment can be aware whether the UL grant or the PDSCH is transmitted on the region except the DL grant region 20 by referring to the index of the DL grant detected RBG, RB, slot, symbol, RE, eREG or eCCE unit (or bundle).

Meanwhile, E-PDCCH may not be limited to a specific antenna port only. Hence, one of antenna ports 7, 8, 9 and 10 can be used for the E-PDCCH transmission. An antenna port index corresponding to a DL grant detected RE can implicitly indicate whether the UL grant or the PDSCH is transmitted. Hence, the user equipment can be aware whether the UL grant or the PDSCH is transmitted by obtaining the index of the antenna port corresponding to the DL grant detected RE. For instance, if a specific antenna port (e.g., antenna port 9) is used, this antenna port index 9 can indicate whether PDSCH is transmitted on the rest of RE that uses the antenna port 9.

For another instance, if a specific antenna port (e.g., antenna port 9) is used, this antenna port index 9 can indicate whether PDSCH is transmitted on the rest of RE of all antenna ports including the antenna port 9.

The above-described implicit resource allocation indication is applicable to E-PDCCH transmitted in DL/UL search spaces of all types configurable in a normal subframe and a special subframe. Although FIG. 11 shows that E-PDCCH is configured with PDSCH by TDM+FDM in a normal subframe and a special subframe, if the E-PDCCH is configured by FDM, as shown in FIG. 11B, the above-described implicit resource allocation indication is applicable thereto as well.

As mentioned in the foregoing description, FIG. 11A and FIG. 11B show the slot-based or symbol-based configurations for example. And, the same principle is applicable to the cases of transmitting the DL grant and the UL grant by multiplexing them variously by RE unit, eREG unit, eCCE unit and the like.

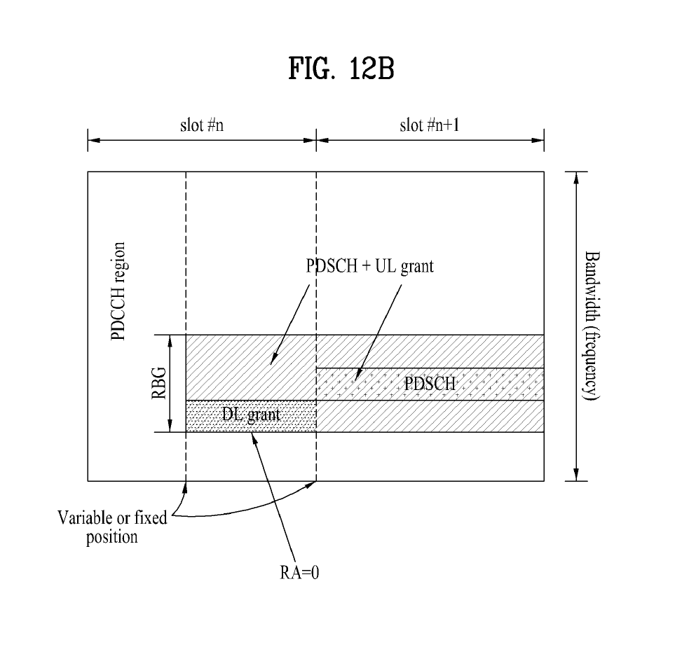

FIG. 12A shows an implicit resource assignment scheme in case that RA bit indicates 1, when E-PDCCH (enhanced physical downlink control channel) is transmitted with PDSCH by having a TDM (time division multiplexing) & FDM (frequency division multiplexing) mixed scheme applied thereto. FIG. 12B shows an implicit resource assignment scheme in case that RA bit indicates 0, when E-PDCCH (enhanced physical downlink control channel) is transmitted with PDSCH by having a TDM (time division multiplexing) & FDM (frequency division multiplexing) mixed scheme applied thereto.

In case that E-PDCCH is transmitted with PDSCH by a hybrid type of TDM and FDM, if an RA field of a DL scheduling assignment indicates a corresponding RBG (or RB) as ‘0’ or ‘1’, FIG. 12A exemplarily shows how a user equipment interprets the corresponding indication.

In this case, ‘RA=1’ is assumed as meaning that PDSCH is assigned to the corresponding RBG or RB according to an existing interpretation. In FIG. 12A, if the RA bit indicating the RBG (or RB) is set to 1, the user equipment can determine that the PDSCH is transmitted on the rest of regions except the region occupied by a DL grant. In doing so, the user equipment can interpret the meaning that the PDSCH is assigned to the RBG (or RB) and that a rate matching or puncturing is performed by the region amounting to the region occupied by the DL grant.

Referring to FIG. 12B, if the RA bit indicating a corresponding RBG (or RB) is set to 0, a user equipment can understand that a UL grant is present at a prescribed location (e.g., a second slot (slot #(n+1)) in the corresponding RBG (or RB) and that PDSCH is transmitted on a region except a resource region occupied by a DL grant and a resource region occupied by the UL grant. As mentioned in the foregoing description, the DL grant and/or the UL grant is assumed as transmitted in a manner of rate-matching or puncturing the PDSCH.

Although a single RBG (or RB) is mentioned in the description with reference to FIG. 12A or FIG. 12B, it is a matter of course that a base station can inform a user equipment of DL/UL grant PDSCH assignment information on N RBGs (or RBs) by a combination of values of a multitude of RA bits in a manner of bundling N RBGs (or RBs).

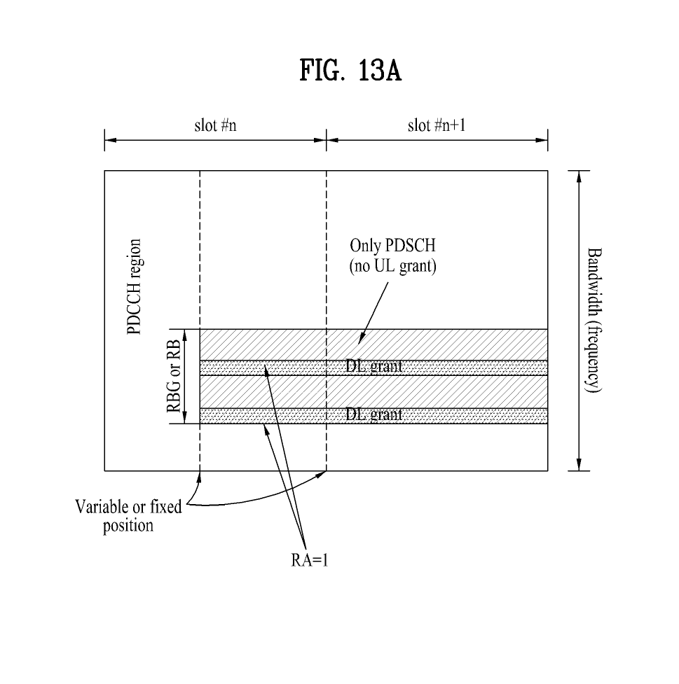

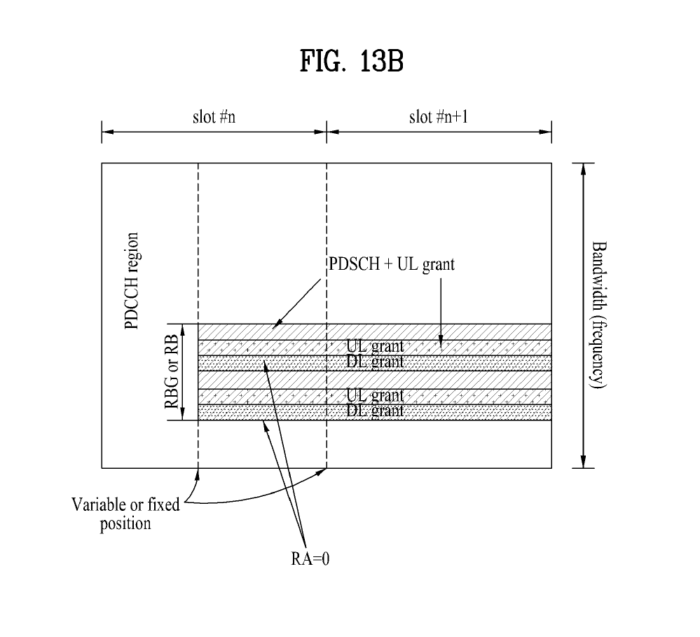

FIG. 13A shows an implicit resource assignment scheme in case that RA bit indicates 1, when E-PDCCH (enhanced physical downlink control channel) is transmitted by FDM (frequency division multiplexing) scheme. FIG. 13B shows an implicit resource assignment scheme in case that RA bit indicates 0, when E-PDCCH (enhanced physical downlink control channel) is transmitted by FDM (frequency division multiplexing) scheme. And, the former implicit resource assignment schemes described with reference to FIG. 12A and FIG. 12B can be exactly applied thereto.

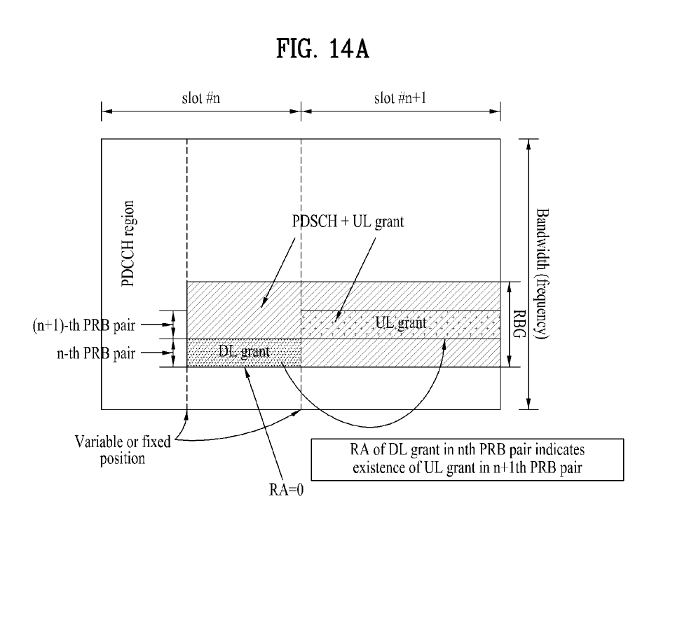

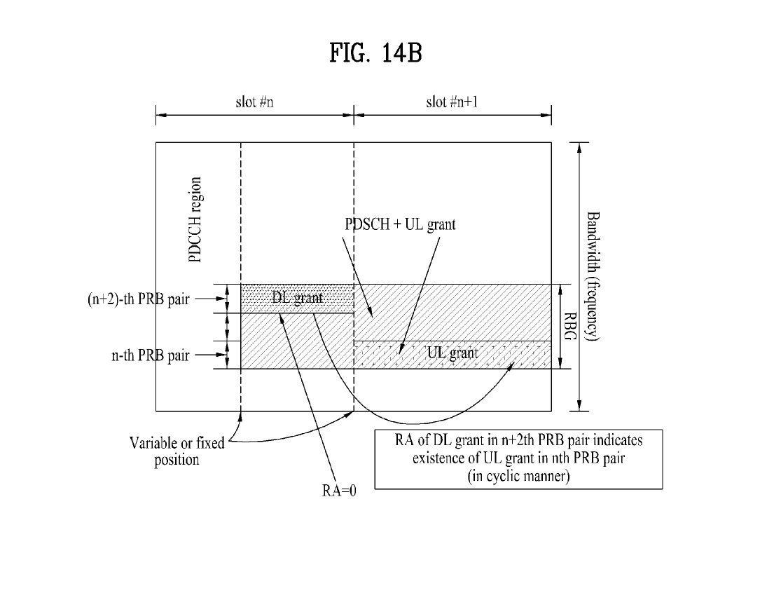

FIG. 14A and FIG. 14B show implicit resource assignment schemes in case that RA bit indicates 0, when E-PDCCH (enhanced physical downlink control channel) is transmitted with PDSCH by having a TDM (time division multiplexing) & FDM (frequency division multiplexing) mixed scheme applied thereto, respectively.

In particular, FIG. 14A and FIG. 14B show methods of indicating a UL grant location in a predefined PRB pair (or PRB) implicitly. For example that a DL grant indicates a UL grant location, referring to FIG. 14A and FIG. 14B, a UL grant is present at a PRB pair (e.g., (n+1)^{th} PRB pair) right next to a DL grant present PRB pair (e.g., n^{th} pair). In particular, if the DL grant is detected from a first slot of the n^{th} PRB pair and RA is equal to 0 (i.e., RA=0), a user equipment can determine that the UL grant exists in a second slot of the (n+1)^{th} PRB pair.

Like FIG. 14B, if the DL grant is detected from a first slot (e.g., slot #n) of an (n+2)^{th} PRB pair and RA is equal to 0 (i.e., RA=0), it means a second slot (e.g., slot #(n+1) of the n^{th} PRB pair that is a right next cyclic PRB pair in PRB pairs (e.g., RBG in a pre-designated size, RBG=3 PRB in FIG. 14A and FIG. 14B).

If FDM is applied, it may mean that a UL grant is present at a right next PRB pair without slot discrimination or a user equipment is informed that a UL grant exists on a right next subcarrier.

In FIG. 14A and FIG. 14B, a DL grant region and a UL grant region can be configured with a bundle of RE. Hence, slot discrimination is not performed in general. For instance, a plurality of scattered REs configure a single DL grant. Likewise, a multitude of REs existing in other regions are bundled to configure a UL grant. In this case, using eREG corresponding to a basic bundling unit of REs, K eREGs can become a single DL or UL grant. In this case, the meaning of ‘adjacent’ or ‘next’ may mean a next index or a next physical/logical location in viewpoint of RE, eREG, port, PRB, symbol or slot.

In the above description so far, the implicit resource allocations in transmitting E-PDCCH according to various embodiments of the present invention are explained. The implicit resource allocation schemes according to various embodiments of the present invention are identically applicable to the case of transmitting R-PDCCH corresponding to a control information channel for a relay node as well as E-PDCCH corresponding to a control information channel for a user equipment. Furthermore, the implicit resource allocation schemes according to various embodiments of the present invention are applicable to all the newly proposed control channels transmitted in a data channel (PDSCH) region in LTE system.

The above-described embodiments may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment. And, it is apparently understandable that a new embodiment may be configured by combining claims failing to have relation of explicit citation in the appended claims together or may be included as new claims by amendment after filing an application.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Accordingly, a method of transmitting and receiving resource allocation information in a wireless communication system and apparatus therefor are industrially applicable to various wireless communication systems including 3GPP LTE system, 3GPP LTE-A system and the like.

What is claimed is:

1. A method of receiving resource allocation information by a user equipment in a wireless communication system, the method comprising:
receiving E-PDCCH (enhanced-physical downlink control channel) including a downlink (DL) grant on a specific resource region from a base station;
decoding a resource allocation (RA) field of a DCI format of the received E-PDCCH; and
determining whether PDSCH (physical downlink shared channel) is transmitted on the rest of the specific resource region except a DL grant region or the rest of the specific resource region except the DL grant region and a UL grant region existing in the specific resource region depending on a result of the decoded RA field.

2. The method of claim 1, wherein the specific resource region comprises a region configured by RBG (resource block group) or RB (resource block) unit.

3. The method of claim 1, wherein the DL grant is received by a unit of one selected from the group consisting of RBG (Resource Block Group), RB (Resource Block), slot, symbol, RE (Resource Element), eREG (enhanced Resource ElementG), eCCE (enhanced Control Channel Element) and combination thereof.

4. The method of claim 1, wherein a location of the UL grant comprises a pre-designated location or is determined by the DL grant.

5. The method of claim 4, wherein if the location of the UL grant is determined by the DL grant, the location of the UL grant is determined based on one selected from the group consisting of indexes of RBG (Resource Block Group), RB (Resource Block), slot, symbol, RE (Resource Element), eREG (enhanced Resource ElementG) and eCCE (enhanced Control Channel Element), on which the DL grant is received.

6. The method of claim 4, wherein the UL grant is located by one of RBG (Resource Block Group) unit, RB (Resource Block) unit, slot unit, symbol unit, RE (Resource Element) unit, eREG (enhanced Resource ElementG) unit, eCCE (enhanced Control Channel Element) unit, subcarrier unit and unit configured by combination thereof.

7. The method of claim 1, wherein the E-PDCCH is received with the PDSCH by having FDM (frequency division multiplexing) applied thereto or by having a hybrid the FDM and TDM (time division multiplexing applied thereto.

8. A method of transmitting resource allocation information by a base station in a wireless communication system, the method comprising:
transmitting E-PDCCH (enhanced-physical downlink control channel) including a downlink (DL) grant on a specific resource region to a user equipment,
wherein the E-PDCCH includes a resource allocation (RA) field of a DCI format,
wherein a first indication value of the RA field indicates that PDSCH (physical downlink shared channel) is transmitted on the rest of the specific resource region except a DL grant region and
wherein a second indication value of the RA field indicates that the rest of the specific resource region except the DL grant region and a UL grant region existing in the specific resource region.

9. The method of claim 8, wherein the specific resource region comprises a region configured by RBG (resource block group) or RB (resource block) unit.

10. The method of claim 8, wherein the DL grant is transmitted by a unit of one of RBG (Resource Block Group), RB (Resource Block), slot, symbol, RE (Resource Element), eREG (enhanced Resource ElementG), eCCE (enhanced Control Channel Element) and combination thereof.

11. The method of claim 8, wherein a location of the UL grant comprises a pre-designated location or is determined by the DL grant.

12. The method of claim 11, wherein if the location of the UL grant is determined by the DL grant, the location of the UL grant is determined based on one selected from the group consisting of indexes of RBG (Resource Block Group), RB (Resource Block), slot, symbol, RE (Resource Element), eREG (enhanced Resource ElementG) and eCCE (enhanced Control Channel Element), on which the DL grant is received.

13. A user equipment of receiving resource allocation information in a wireless communication system, the user equipment comprising:
a receiver configured to receive E-PDCCH (enhanced-physical downlink control channel) including a downlink (DL) grant on a specific resource region from a base station; and
a processor configured to decode a resource allocation (RA) field of a DCI format of the received E-PDCCH, the processor determining whether PDSCH (physical downlink shared channel) is transmitted on the rest of the specific resource region except a DL grant region or the rest of the specific resource region except the DL grant region and a UL grant region existing in the specific resource region depending on a result of the decoded RA field.

14. The user equipment of claim 13, wherein a location of the UL grant comprises a pre-designated location or is determined by the DL grant.

15. The user equipment of claim 14, wherein if the location of the UL grant is determined by the DL grant, the processor obtains the location of the UL grant based on one selected from the group consisting of indexes of RBG (Resource Block Group), RB (Resource Block), slot, symbol, RE (Resource Element), eREG (enhanced Resource ElementG) and eCCE (enhanced Control Channel Element), on which the DL grant is received.

16. A base station of transmitting resource allocation information in a wireless communication system, the base station comprising:
a transmitter configured to transmit E-PDCCH (enhanced-physical downlink control channel) including a downlink (DL) grant on a specific resource region to a user equipment,
wherein the E-PDCCH includes a resource allocation (RA) field of a DCI format,
wherein a first indication value of the RA field indicates that PDSCH (physical downlink shared channel) is transmitted on the rest of the specific resource region except a DL grant region and
wherein a second indication value of the RA field indicates that the rest of the specific resource region except the DL grant region and a UL grant region existing in the specific resource region.

17. The base station of claim 16, wherein the specific resource region comprises a region configured by RBG (resource block group) or RB (resource block) unit.

18. The base station of claim 17, wherein the DL grant is transmitted by a unit of one selected from the group consisting of RBG (Resource Block Group), RB (Resource Block), slot, symbol, RE (Resource Element), eREG (enhanced Resource ElementG), eCCE (enhanced Control Channel Element) and combination thereof.
